(19) United States
(12) Patent Application Publication
(10) Pub. No.: US 2002/0076370 A1
(43) Pub. Date: Jun. 20, 2002

(54) Meta-stable radical generator with enhanced output

(76) Inventors: Sik-Lam Wong, San Leandro, CA (US); Henry Ming-Fat Sze, Pleasanton, CA (US); Siu-Kwong Lam, San Ramon, CA (US); Steven Pomeroy, San Leandro, CA (US)

Correspondence Address: WIGGIN & DANA LLP, ATTENTION: PATENT DOCKETING, ONE CENTURY TOWER, P.O. BOX 1832, NEW HAVEN, CT, 06508-1832, US

(21) Appl. No.: 09/969,906

(22) Filed: Oct. 3, 2001

Related U.S. Application Data
(63) Continuation-in-part of application No. 09/571,128, filed on May 15, 2000, now abandoned.
Application No. 09/571,128 is a division of application No. 09/041,589, filed on Mar. 12, 1998.
Application No. 09/041,589 is a division of application No. 08/481,172, filed on Jun. 7, 1995.

(51) Int. Cl. B01J 19/08

(52) U.S. Cl. 422/186.12; 422/186.07; 422/186.04; 204/164; 204/176

(57) ABSTRACT

There is disclosed an apparatus and method using meta-stable radicals to treat air and porous solid mediums contaminated with organic material including bacteria, viruses, microbes and chemical contaminants. In a preferred embodiment, the meta-stable radicals are generated using a pulsed corona discharge apparatus. Further, in a most preferred embodiment, the meta-stable radical mixture includes ozone.

### CROSS REFERENCE TO RELATED APPLICATIONS

The present application is a continuation-in-part of application Ser. No. 09/571,128 that was filed May 15, 2000, which in turn is a division of application Ser. No. 09/041,589 that was filed Mar. 12, 1998 (now issued U.S. Pat. No. 6,080,362), which in turn is a division of application Ser. No. 08/481,172 that was filed Jun. 7, 1995 (now issued U.S. Pat. No. 5,765,054). U.S. Pat. Nos. 6,080,362 and 5,765,054 are incorporated by reference herein in their entirety.

### BACKGROUND OF THE INVENTION

This invention relates to a generator for the production of meta-stable radicals for chemical and biological remediation. More particularly, a meta-stable radical generator utilizes a pulsed power supply to enhance meta-stable radical production. The meta-stable radicals are used to convert volatile organic and biological compounds in the air, liquid or the soil to innocuous compounds. Preferably, the meta-stable radicals are a mixture of one or more different meta-stable radicals wherein one of the meta-stable radicals is ozone.

Radicals, particularly those at an excited state and thus meta-stable, are effective to remediate contaminated water. Dutch Patent Application NL 90001118 discloses the use of radicals to treat water. The present inventors have discovered that these radicals are also effective to remediate biological and chemical contaminants from air and porous solid mediums.

Ozone (O₃) is a strong oxidizer that is used to convert harmful organic compounds into innocuous compounds. U.S. Pat. No. 4,076,617 to Bybel et al. discloses a system for the remediation of liquid waste. Ultrasonic waves break up solid particles suspended in the liquid waste and the fine particles then form an emulsion in the liquid. An ozone stream is passed through the emulsion oxidizing the organic contaminants.

In U.S. Pat. No. 4,076,617, ozone is formed by passing dry oxygen or dry air through a corona discharge grid. The ozone yield is disclosed to be from about 3% to about 6%. The remainder of the gas recombines to form oxygen or nitrogen compounds.

U.S. Pat. No. 5,409,616 to Garbutt et al. discloses an ozone generator containing a molecular sieve to increase the oxygen content from about 20% (in ambient air) to in excess of 85% and to extract moisture from the gas. An alternating current power supply connected to a 5000 volt alternating current transformer converts the oxygen to ozone.

Both the Bybel et al. and Garbutt et al. patents are incorporated by reference in their entireties herein.

Ozone has been utilized for the bioremediation of organic compounds suspended or dissolved in a liquid medium. The ozone is bubbled through the liquid medium and, to enhance the surface area of the ozone bubbles, bubble breaking spargers have been utilized. However, to the best of our knowledge, ozone and other meta-stable radicals have not been successfully applied to the bioremediation of either a gaseous medium or a solid medium.

There is a need to disinfect gaseous media, such as the air in a hospital of germs, spores, and viruses or the air of a laboratory of volatile organic compounds. Presently, the air in these environments is not recirculated, but is discharged through a filter to the outside environment. This method presents the potential for releasing harmful compounds to the outside environment. Further, any energy applied to heat or cool that air is lost when the air is discharged.

Until the present invention, meta-stable radicals, including ozone, have not been applied to the remediation of air or porous medium because the concentration of contaminants is usually low and it has proven difficult to ensure contact between the meta-stable radicals and the contaminants without providing high concentrations of meta-stable radicals. High concentrations of meta-stable radicals, such as ozone, are both expensive and potentially hazardous.

Porous solids, such as soil, are usually remediated of fungi through the application of a fungicide such as dimethyl bromide. The fungicides are typically toxic. A mixture of meta-stable radicals, particularly one including ozone, would be an environmentally sound replacement for fungicides. The remediation affect of meta-stable radicals could convert the contaminants to relatively innocuous compounds. Because ozone is unstable, when released to the air, it would rapidly convert to oxygen.

There remains, therefore, a need for a meta-stable radical generator with enhanced output and a mechanism to apply meta-stable radicals for the bio- and chemical remediation of gaseous and porous media.

### SUMMARY OF THE INVENTION

Accordingly, it is an object of one embodiment of the invention to utilize meta-stable radicals to remove organic contaminants from either a gaseous medium or from a porous solid medium. For the purposes of this invention, the term “organic materials” is intended to include chemical and biological materials and specifically includes microbial, spores (e.g., anthrax), viral, and bacterial materials. Further, for the purposes of this invention, the term “meta-stable radicals” refers to atoms and molecules that exist at an excited stated for seconds to many minutes, such as atomic oxygen and nitrogen as well as excited forms and states of oxygen and nitrogen molecules including ozone.

It is a feature of this embodiment that the gaseous medium is passed through a reaction chamber that contains a porous material to increase the surface area available for the reaction between the meta-stable radicals and the contaminants. Meta-stable radicals can be generated independently in a device such as a pulsed corona reactor or a silent discharge plasma and can be introduced separately into the reaction chamber with the porous material. Alternatively, the contaminated gaseous medium can pass through the pulsed corona reactor or silent discharge plasma and be co-mingled with the meta-stable radicals prior entering the reaction chamber.

Preferably, the meta-stable radicals is a mixture of one or more different meta-stable radicals wherein one of the meta-stable radicals is ozone. The ozone diffuses to the surface of the medium, and on entering the atmosphere, can be converted to oxygen via a conventional technique such as exposure to activated carbon, heat or ultra violet light.

In accordance with a second embodiment of the invention, there is provided a method for treating porous solid materials contaminated with organic material including, but not limited to, bacteria, spores, virus and chemical contaminants. Such a method allows the treatment of contaminated filters using meta-stable radicals generated by a pulsed corona discharge apparatus or a steady state device such as a silent discharge plasma device. Preferably, the meta-stable radicals is a mixture of one or more different meta-stable radicals wherein one of the meta-stable radicals is ozone.

In accordance with a third embodiment of the invention, there is provided a method for treating porous solid materials contaminated with organic material including, but not limited to, bacteria, spores, virus and chemical contaminants. Such a method allows the treatment of contaminated filters using meta-stable radicals. The porous solid medium is exposed to alternating voltage pulses having an intensity and duration effective to generate a quantity of meta-stable radicals effective to destroy the organic medium. Preferably, the meta-stable radicals is a mixture of one or more different meta-stable radicals wherein one of the meta-stable radicals is ozone.

The above stated objects, features and advantages will become more apparent to those skilled in the art from the specification and drawings that follow.

### IN THE DRAWINGS

FIG. 1 is a schematic of the overall configuration of the present invention.

FIG. 2 graphically illustrates the relationship between the intensity of an electron beam and the depth of penetration of electrons emerging from an anode.

FIG. 3 graphically illustrates the relationship between the electron beam intensity and the depth of penetration of electrons emerging from a titanium anode.

FIG. 4 illustrates a condensation chamber for separating ozone from oxygen.

FIG. 5 graphically illustrates a voltage pulse effective for the generation of ozone.

FIG. 6 illustrates a chamber for the purification of a gaseous medium.

FIG. 7 illustrates a system for the purification of a porous solid medium.

FIG. 8 illustrates in longitudinal cross-sectional representation the reactor portion of a pulsed corona discharge apparatus useful in the present invention.

FIG. 9 illustrates in longitudinal cross-sectional representation the power supply portion of the system of a pulsed corona discharge apparatus useful in the present invention.

### DETAILED DESCRIPTION

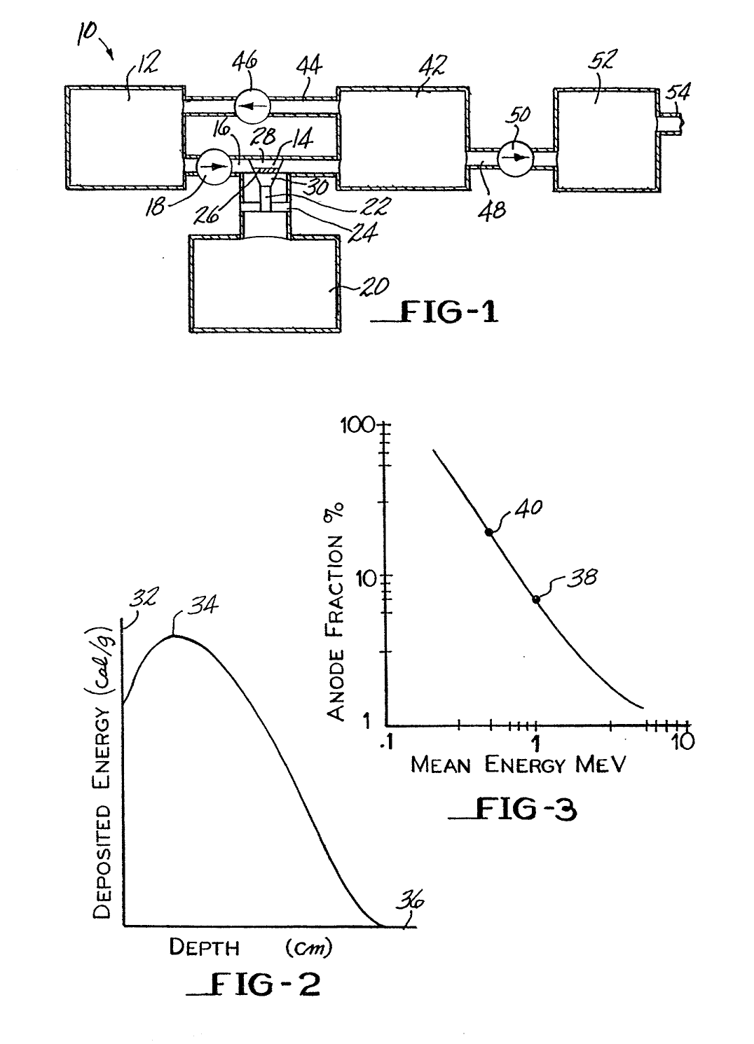

As shown in FIG. 1, the power supply 20 and the electron gun may be a pulsed corona discharge apparatus that typically uses pulsed high voltage. The generator 10 produces ozone, one form of meta-stable radical useful in the present invention, using a cryogenic source 12 that can be any commercial unit for the production of liquid oxygen, hydrogen or other radical source. Cryogenic oxygen is delivered to an irradiation chamber 14 through a first conduit 16. A pump 18 delivers a desired volume of cryogenic oxygen at a desired flow rate.

The cryogenic oxygen is delivered to the irradiation chamber 14 either as a liquid, at a temperature below the boiling point of oxygen (90 K) or as a cryogenic gas, below the boiling point of ozone (161 K).

In one embodiment of the invention, the power supply 20 is a repetitively pulsed electron beam accelerator such as a linear accelerator, a compact linear induction accelerator, a van de Graf accelerator or a Marx circuit with a pulse forming network. More detailed descriptions of such the devices are found in U.S. Pat. Nos. 3,702,973 to Daugherty et al., 3,883,413 to Douglas-Hamilton and 3,956,634 to Tran et al. all of which are incorporated by reference in their entireties herein.

The power supply 20 delivers a stream of electrons through an electron gun 22 focused by a collimator 24 such as an adjustable magnetic ring. The electron stream impacts a target anode 26 that forms a front wall of the first conduit 16. Most of the electrons pass through the anode 26 and into the first conduit 16 irradiating the flowing oxygen.

The irradiation chamber 14 is defined by the anode 26, a back wall 28 of the first conduit 16 and the diverging walls 30 of the electron stream. The irradiation chamber 14 is sized such that it has an areal density about equal to the maximum depth of penetration of the electrons emerging from the anode 26. The areal density is equal to the density (g/cm³) times the depth (cm) of the irradiation chamber. As shown in FIG. 2, the energy deposited on the flowing stream of oxygen, axis 32, achieves a maximum 34 when penetrating an anode foil having a relatively thin cross-sectional thickness, axis 36.

The maximum value is dependent on the anode material and the electron beam intensity. FIG. 3 illustrates that for a titanium foil anode with a thickness of 0.002 inch to 0.003 inch, only about 5% of the electron energy is lost when the electron beam is operated at 1 megavolt, reference point 38, and less than 10% is lost when the operating voltage is 0.6 megavolt, reference point 40.

Referring back to FIG. 1, in one embodiment, the power source 20 is a compact linear induction accelerator operating at a voltage of from about 0.5 megavolt to about 10 megavolts and preferably operating at a voltage of from about 0.8 megavolt to about 1.2 megavolts with the optimal operating voltage dependent on the throughput rate of the cryogenic oxygen. The energy produced by the compact linear induction accelerator is about 230 joules per pulse at an operating voltage of about 0.6 megavolt with a pulse rate of from about 50 to about 150 pulses per second. The optimal voltage repetition rate is determined experimentally. The rate is dependent on the desired flow rate, the meta-stable radical and ozone concentration and other operating parameters.

When the cryogenic oxygen source 12 provides liquid oxygen to the irradiation chamber 14, ozone concentrations up to 33%, by volume, are possible by irradiation of the liquid oxygen. The 33% maximum is determined by the equilibrium point at which the ionization rate of ozone molecules is equal to that of the oxygen molecules, the number of electrons associated with ozone molecules is equal to the number of electrons associated with oxygen molecules.

Full conversion of all oxygen molecules to ozone molecules requires an energy of 717 calories per gram so that to obtain a product with 33% ozone, a accumulated dose of 240 cal/gm is required. This is equal to approximately 40 pulses from the compact linear induction accelerating requiring that the liquid oxygen dwell in the irradiation chamber for approximately 0.4 seconds. Accordingly, the cross-sectional area of the irradiation chamber and the flow rate generated by first pump 18 are selected such that the flowing oxygen is within the irradiation chamber for a time of from about 0.3 to about 1 second and preferably, for a time of from about 0.35 to about 0.5 seconds.

One advantage of irradiating the oxygen at cryogenic temperatures is the capability to exploit the boiling point and/or density differences between ozone and oxygen. For example, as cryogenic gases, the density of ozone is 1.5 times the density of oxygen.

As a further advantage, if liquid oxygen is employed, the thermal conductivity of liquid oxygen is greater than that of gaseous oxygen enhancing cooling of the anode.

The irradiated cryogenic oxygen and meta-stable radicals flows to a concentrator 42 where the ozone or meta-stable radicals are separated from residual oxygen or other radical source. Ozone has a higher density than oxygen so, in one embodiment, the ozone concentrator 42 is a static flow chamber where the liquid ozone gravimetrically separates from the liquid oxygen. The liquid oxygen is recycled through a second conduit 44, driven by a pump 46 back to the cryogenic oxygen source 20. The ozone are drawn off through a third conduit 48, optionally driven by a pump 50 and delivered to a vaporization unit 52 where the liquid ozone is converted into ozone gas and stored until dispensed through an output conduit 54.

If the cryogenic oxygen/ozone/meta-stable radical mixture is delivered to the concentrator 42 at a temperature of between 90 K and 161 K, between the boiling point of oxygen and the boiling point of ozone, a condensation coil 56, as illustrated in FIG. 4, having a temperature between 91 K and 160 K may be utilized to condense the ozone. The first conduit 18 delivers a gaseous mix 58 of oxygen, ozone, and meta-stable radicals to the concentrator 42. This temperature range may be achieved by providing the cryogenic oxygen to the irradiation chamber as a gas in this temperature range or by heating the liquid mixture of oxygen, ozone downstream of the irradiation chamber to this temperature range. The gaseous mix 58 contacts the condensation coil 56. The ozone condenses to a liquid 60 along a bottom surface 62 of the ozone concentrator 42 and is drawn off through the third conduit 48. Gaseous oxygen 64 returns through the second conduit 44 to the cryogenic oxygen source.

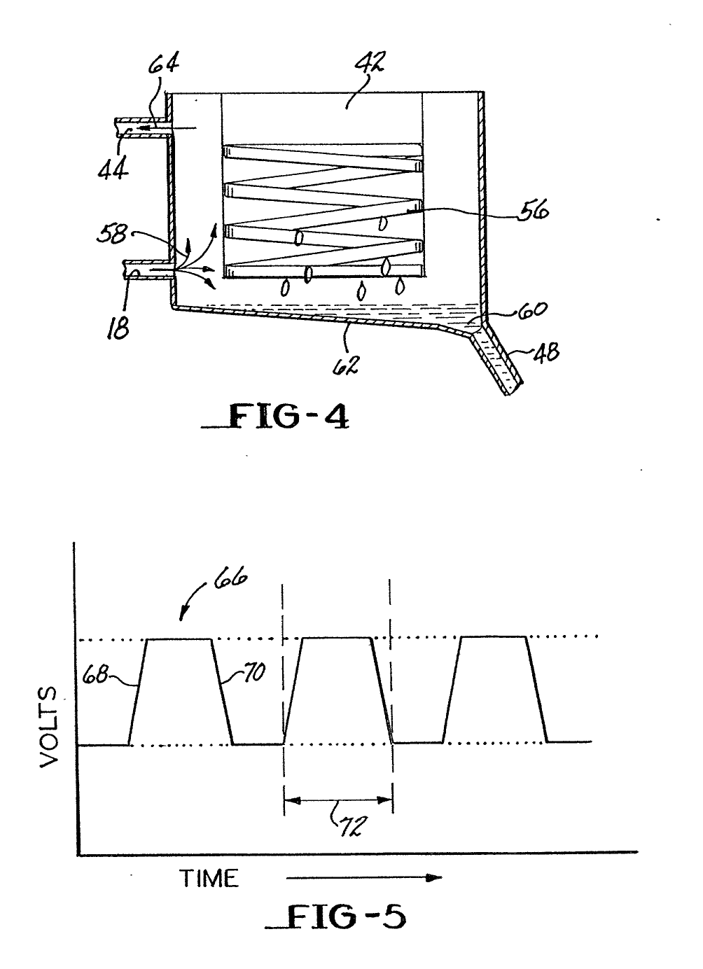

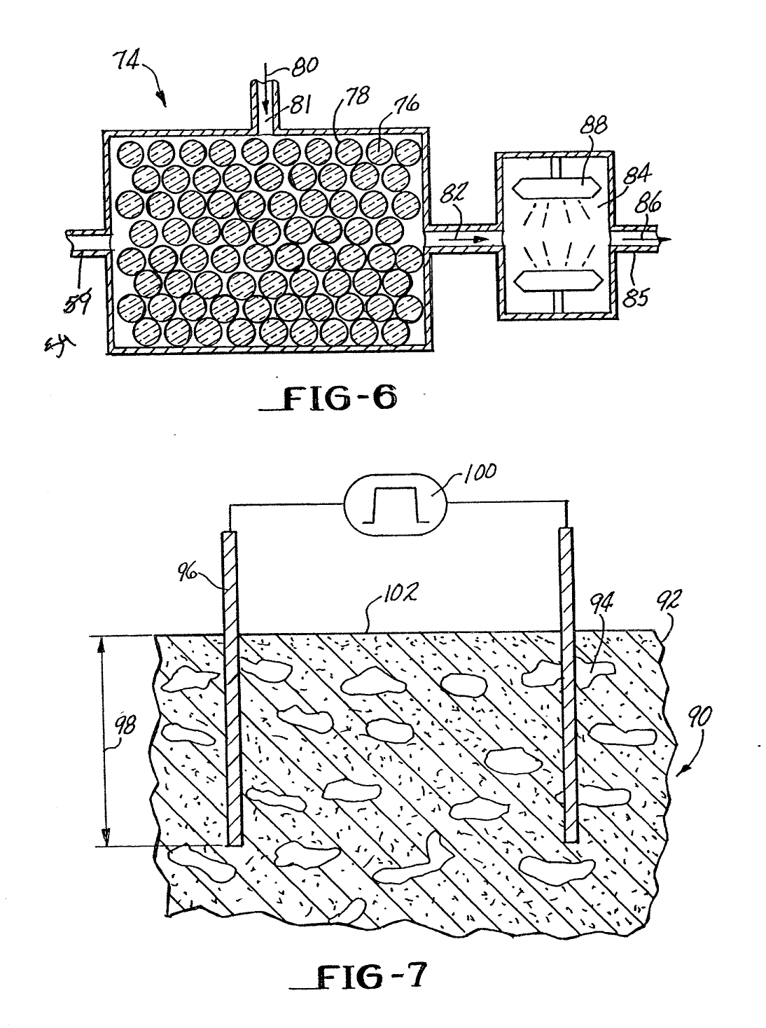

As illustrated in FIG. 5, the pulsed source varies between a base line voltage of zero volts and a peak voltage of at least 10 kilovolts and potentially up to 750 kilovolts. The voltage pulses 66 utilize a fast rise time 68. Preferably, the rise time is from about 2 nanoseconds to about 80 nanoseconds and most preferably, from about 2 nanoseconds to about 20 nanoseconds.

The fall time 70 is relatively short to minimize energy not used for ozone generation. The fall time 70 is from about 2 nanoseconds to about 100 nanoseconds and preferably from about 2 nanoseconds to about 20 nanoseconds. The pulse width 72, as well as the repetition rate are optimized for each irradiation chamber design and gas flow rate. For the design illustrated in FIG. 1 and an oxygen flow rate of 1 standard ft³/min., a preferred pulse width is from about 20 nanoseconds to about 100 nanoseconds and a preferred repetition rate is from 20 per second to about 500 per second.

Meta-stable radicals will exist beyond the irradiation chamber. Accordingly, the destruction of biological agents and chemical compounds can occur in the reaction chamber where the contaminated effluent (gas or liquid) can mix with the meta-stable radicals to effect the destruction of the contaminants.

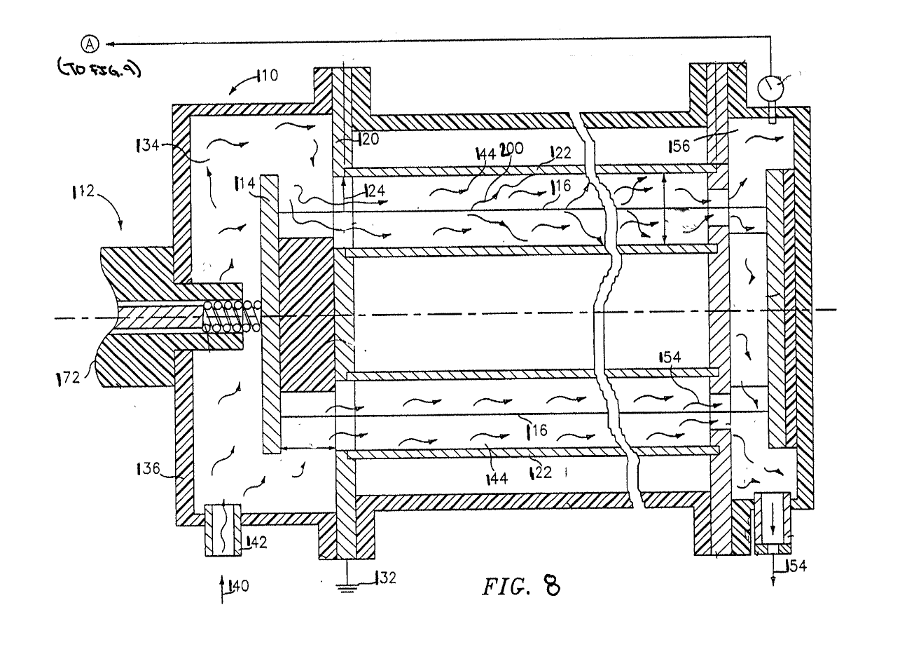

FIG. 6 illustrates a reaction chamber 74 effective to disinfect air containing biological contaminants such as germs or viruses, as well as volatile organic compounds such as organic solvents from a gaseous medium such as hospital or laboratory air. The reaction chamber 74 is a hermetic enclosure having a first inlet through which an ozone stream is introduced, such as from the output conduit 54 of the ozone generator of FIG. 1.

Contained within the reaction chamber 74 is a surface area increasing medium 76 such as inert beads of glass or ceramics. This surface increasing medium concentrates or traps the contaminants. Trapping the contaminants allows the ozone and other meta-stable radicals to attack the contaminants over a period of time, thereby increasing the efficiency of the scheme. The outside diameter of the inert beads is optimized for disinfecting efficiency and typically will range from about 1 mm to about 10 mm. The inert beads increase the surface area inside the reaction chamber by several factors of magnitude. The beads 76 may be coated with a suitable catalyst 78 to promote the oxidation reaction. One suitable catalyst is titanium oxide. Furthermore, the reaction chamber can be a porous medium such as a filter or an electrostatic precipitator.

The ozone reacts with the biological and organic compounds to render the contaminants environmentally innocuous. The size of the reaction chamber 74 and the rate of flow of air 80 through a second inlet 81 into the reaction chamber are selected to be effective to provide sufficient time in the reaction chamber for complete air disinfection and cleaning. Typically, a dwell time within the reaction chamber 74 is from about 0.1 second to about 60 seconds and preferably from about 3 seconds to about 20 seconds.

In a closed environment such as a hospital or laboratory, even trace amounts of ozone may constitute an irritant to occupants. Accordingly, the output 82 is preferably directed to an ozone destroying chamber 84 through outlet 85 before being recirculated 86 into the hospital or laboratory environment. Located within the ozone destroying chamber 84 is any device effective to promote the conversion of O₃ back to O₂ such as heating coils or an ultraviolet light source 88. A scrubber may also be used to remove unreacted ozone before the air is released back into a room or building.

The pulsed electric field illustrated in FIG. 5 is effective to disinfect a porous solid medium by the method illustrated in FIG. 7. A porous solid medium 90 includes a solid component 92 interspersed with air pockets 94. Typical porous solid media include soil, sand, cinder block, HEPA filters and activated carbon.

A plurality of electrodes 96 are embedded into the porous solid media 90. The depth 98 is determined by the depth of disinfection required as well as the power available to be applied to the electrodes. For a pair of electrodes 96 having a surface area of 10 cm² and spaced apart by a distance of 2 cm utilizing a 50 kilovolt alternating current pulse power supply 100, a depth 98 can be satisfactorily disinfected in less than 10 minutes.

The alternating current power supply 100 provides a plurality of alternating current voltage pulses between the electrode 96. The voltage pulses are of an intensity and duration that is effective to generate a quantity of ozone in the air pockets 94. The ozone disinfects organic material in the solid component 92 as it migrates to the surface 102 where it diffuses to the air and can be converted back to oxygen by standard techniques such as exposure to heat, ultra violet light and/or activated carbon.

An effective voltage applied by the alternating current power supply 100 is from about zero volts as the baseline to from 10 to 200 kilovolts as the peak voltage. Suitable voltage pulse widths are from about 0.02 milliseconds to about 20 milliseconds with a frequency of from about 50 pulses per second to 50,000 pulses per second. The alternating current voltage is applied to the electrodes for a time of from about 2 seconds to about 5 minutes to effectively disinfect the porous solid medium. The peak voltage, repetition rate, pulse width, gas species and duration of application are determined by the condition and the amount of porous solid medium to be disinfected.

Preferably, meta-stable radicals are generated using a pulsed corona discharge apparatus. One such corona discharge apparatus, ideal for this application, is disclosed in commonly owned U.S. Pat. No. 6,264,898 to Michael W. Ingram, which is incorporated by reference in its entirety herein. Such a device could produce a range of meta-stable radicals.

Inside the corona region, high-energy electrons, ultra violet radiation and meta-stable radicals are generated. The resultant mixture is effective to breakdown chemical bonds and attack biological agents in the effluent or surface to be treated. The meta-stable radicals, including ozone, will exist beyond the corona region. Accordingly, the destruction of biological agents and chemical compounds can occur in the reaction chamber where in the contaminated effluent can mix with the meta-stable radicals to effect the destruction of the contaminants.

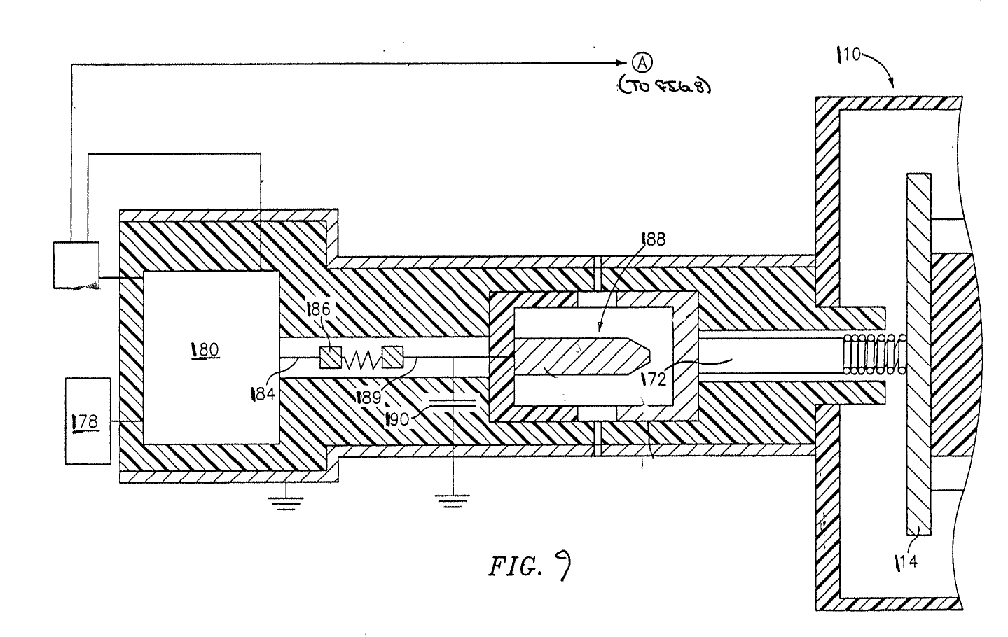

FIG. 8 is an illustration of the pulsed corona discharge apparatus taught in U.S. Pat. No. 6,264,898 to Ingram that is useful in the present invention to produce meta-stable radicals. U.S. Pat. No. 6,264,898 is incorporated by reference in its entirety herein. The reaction section 110 includes an electrically conductive header plate 114 that is preferably formed from an electrically conductive metal such as stainless steel.

A plurality of first electrodes 116 are electrically interconnected to the header plate 114. Electrical connection is by any means effective to support the first electrode 116 under tension and includes bolting, welding, soldering and brazing. High voltages will be transferred from the header plate 114 to the first electrode 116 through the electrical interconnection, so low electrical resistance attachment means are preferred.

An electrically conductive reactor plate 120 is spaced from and electrically isolated from the header plate 114. The reactor plate 120 is formed from an electrically conductive metal, preferably stainless steel. The reactor plate is sufficiently strong to support a plurality of second electrodes 122. Electrical isolation between the header plate 114 and the reactor plate 120 is provided by the fluent material around the periphery of the header plate 114 and at first apertures 124 that extend through the reactor plate 120. The first apertures 124 facilitate entrance of the first electrodes 116 into the bore of tubular second electrodes 122.

High voltage pulses applied to the header plate drive electric discharges between the first electrodes 116 and the second electrodes 122, with the discharge completely contained within the volume of tubular electrode 122. Accordingly, a pulsed corona discharge of meta-stable radicals is formed extending between the first electrodes 116 and the second electrodes 122. The voltage potential electrically required to establish the discharge between the first electrode 116 and second electrode 122 is formed by raising the first electrodes 116 to sufficiently high voltage to form the discharge and by having the reactor plate 120, and electrically interconnected to second electrodes 122 at ground potential 132. The high voltage be either positive or negative relative to the grounded component.

Alternatively, the pulsed corona reactor can be in a planar geometry with a plurality of electrodes and high voltage pulses applied to alternating electrodes.

Connected to the reactor plate 120 and circumscribing the reactor plate 120 and header plate 114 to form a gas receiving cavity 134 is gas manifold 136. The gas manifold 136 is hermetically sealed to the reactor plate 120. When contaminated fluent 140 is delivered to the gas receiving cavity 134 through inlet 142, the contaminated fluent fills the gas receiving chamber 134 and flows down a plurality of channels 144 formed by second electrodes 120. The combination of gas manifold 136 and reactor plate 120 containing first apertures 124 results in the inlet 142 effectively providing contaminated fluent 140 to each reaction chamber defined by the combination of a second electrode 122 and first electrode 116.

The second electrodes 122 are electrically interconnected to the reactor plate 120 and extend in a direction way from the header plate 114 for an extended distance. The length of the second electrodes 122 define the reaction chamber length and the time during which contaminated fluent is in contact with the corona discharge and subject to remediation. Typically, the length 144 of the second electrodes 122 is from about six inches to about 60 inches.

The remediated fluent 154 may be discharged directly to the atmosphere or within a gas discharge cavity 156.

The power supply portion 112 is illustrated in cross sectional representation in FIG. 9. An alternating current (AC) power source 178 delivers an alternating current to a power supply 180 that converts the low voltage AC to high voltage direct current (DC) in excess of 10 kilovolts. The output voltage 184 is conducted to isolation impedance 186 that is in series with the DC power supply 180. The isolation impedance is a resistor that has a resistance of at least 20 ohms, preferably about 100 ohms. The isolation impedance electrically isolates the power supply 178 from a high speed switch 188.

The output current 189 is conducted from the isolation resistor 186 to a capacitor 190 then to ground. The capacitor 190 stores electrical energy of at least 0.05 joule, and preferably about 1 joule. The high speed switch 188 then closes connecting the capacitor 190 to the header plate 114 via the power supply electrode 172 conducting a voltage pulse of between about 0.1 kilovolts and 200 kilovolts.

Referring back to FIG. 8, when the power supply electrode 172 applies a voltage pulse to the header plate 114, each of the first electrodes 116 are brought to that same voltage potential. When the voltage potential exceeds the breakdown voltage of the fluent material, a stream of electrons 200 flows between the first electrode 116 and the second electrode 122 in the form of a high energy corona. As the contaminated fluent 144 passes through the energized electrodes 200, collisions between the fluent material and the electrons create highly reactive species called radicals. These radicals, in turn, react with and destroy the pollutant species breaking them down into more innocuous materials.

The pulsed source for the corona reactor varies between a base line voltage of zero volts and a peak voltage of at least 10 kilovolts and potentially up to 100 kilovolts. As in the cryogenic oxygen source, the voltage pulses utilize a fast rise time. The rise time is shorter than the delay on coronal onset. By having the rise time shorter than the coronal onset, the strength of the electric field applied to the irradiation chamber is maximized. Preferably, the rise time is from about 2 nanoseconds to about 80 nanoseconds and most preferably, from about 2 nanoseconds to about 20 nanoseconds. The fall time is relative short to minimize energy not used for meta-stable radical generation. The fall time is from about 2 nanoseconds to about 100 nanoseconds and preferably from about 2 nanoseconds to about 20 nanoseconds. The pulse width as well as the repetition rate are optimized for each corona discharge reactor design and gas flow rate. For the design illustrated in FIGS. 8 and 9 a flow rate of about 1 standard ft³/min., a preferred pulse width is from about 20 nanoseconds to about 100 nanoseconds and a preferred repetition rate is from about 20 per second to about 5000 per second.

An alternating corona discharge apparatus for a different application, is also disclosed in U.S. Pat. No. 4,339,783 to Kinashi et al., which also is incorporated by reference in its entirety herein. Alternatively, a silent discharge plasma device may be used.

Further, porous solid mediums (such as filters and soil) may be treated using the apparatus and method disclosed herein. When contaminated air is passed over a porous solid medium, the contaminants will become trapped within the pores of the medium. Exposing the porous medium to an alternating current voltage pulses will break down the organic contaminants to innocuous compounds. One skilled in the art would recognize that this method may be employed to remediate soils as well as any porous mediums employed within the reaction chamber as discussed above.

Further, in cases where the undesired biological agents and chemicals compounds are attached to surfaces (such as filters and soil), the meta-stable radicals may be sprayed onto the surfaces to disinfect the contaminated surfaces.

It is apparent that there has been provided in accordance with this invention an ozone generator having enhanced ozone production capacity and systems to utilized ozone for bioremediation that fully satisfy the objects, features and advantages set forth hereinbefore. While the invention has been described in combination with specific embodiments and examples thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

We claim:

1. A reaction chamber to remediate air contaminated with organic material, comprising
a hermetic enclosure having a first inlet to introduce meta-stable radicals;
a second inlet to introduce said air contaminated with organic material;
an outlet to remove remediated air; and
a surface increasing medium housed within said hermetic enclosure.

2. The reaction chamber of claim 1, wherein the organic material includes spores.

3. The reaction chamber of claim 1, wherein said meta-stable radicals includes ozone.

4. The reaction chamber of claim 3, wherein ozone is introduced via said first inlet.

5. The reaction chamber of claim 1, wherein the surface increasing medium is comprised of beads of a material inert to the meta-stable radicals.

6. The reaction chamber of claim 5, wherein said material inert to the meta-stable radicals is selected from the group consisting of glass and ceramic.

7. The reaction chamber of claim 5, wherein said beads are porous.

8. The reaction chamber of claim 5, wherein said beads are coated with catalyst.

9. The reaction chamber of claim 1, wherein the surface increasing medium is a porous filter.

10. The reaction chamber of claim 1, wherein the surface increasing medium is an electrostatic precipitator.

11. The reaction chamber of claim 1, further containing an outlet coupling said reaction chamber to a meta-stable radical destroying chamber containing a device effective to convert said meta-stable radicals to stable components.

12. The reaction chamber of claim 11, wherein said device effective to convert said meta-stable radicals to stable components is selected from the group consisting of heating coils, ultraviolet light and activated carbon.

13. The reaction chamber of claim 1, wherein said inlet is coupled to a pulsed corona discharge apparatus.

14. The reaction chamber of claim 13, wherein said pulsed corona discharge apparatus is capable of providing alternating current pulses having an intensity and duration effective to generate meta-stable radicals.

15. The reaction chamber of claim 1, wherein said inlet is coupled to a silent discharge plasma device.

16. A method of treating organic contaminants trapped in a porous solid medium comprising the steps of:
providing said porous solid medium;
passing contaminated air over said porous solid medium thereby trapping said contaminated air in said porous solid medium; and
exposing said porous solid medium to alternating current voltage pulses having an intensity and duration effective to generate meta-stable radicals in said porous solid medium that is effective to destroy said organic contaminants.

17. The method of claim 16, wherein said porous solid medium is comprised of activated carbon.

18. The method of claim 16, wherein said porous solid medium is a HEPA filter.

19. The method of claim 16, wherein said porous solid medium is soil.

20. The method of claim 16, further wherein said meta-stable radicals includes ozone.
